(19) United States
(12) Patent Application Publication
(10) Pub. No.: US 2011/0097436 A1
(43) Pub. Date: Apr. 28, 2011

(54) SLOPING PIN STRUCTURE AND DIE ASSEMBLY USING THE SAME

(75) Inventors: JUN-LIANG MIAO, Shenzhen City (CN); YONG-HUA CHEN, Shenzhen City (CN); SHAO-FENG CAI, Shenzhen City (CN); QING-XIANG ZENG, Shenzhen City (CN); CHANG-LIN CHEN, Shenzhen City (CN); WEI ZHAO, Shenzhen City (CN); XU FANG, Shenzhen City (CN); CHAO-GUO KANG, Shenzhen City (CN)

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/789,600

(22) Filed: May 28, 2010

(30) Foreign Application Priority Data
Oct. 27, 2009 (CN) 200920313379.6

(51) Int. Cl. B29C 45/33

(52) U.S. Cl. 425/577

(57) ABSTRACT

A sloping pin structure applied to a die assembly for assembly within a molding machine such as plastic injection molding machine is disclosed. The sloping pin structure includes a guiding rod and a sloping pin head. The guiding rod has a first resisting surface and a substantially arcuate peripheral second resisting surface. The first resisting surface and the second resisting surface cooperatively form the outer peripheral surface of the guiding rod. The sloping pin head protrudes outwardly from the first resisting surface and is positioned adjacent to one distal end of the guiding rod.

### BACKGROUND

1. Technical Field

This disclosure generally relates to sloping pin structures, and particularly to sloping pin structures and die assemblies using the same.

2. Description of Related Art

Portable electronic device usually includes a housing and a cover detachably assembled to the housing. The housing usually defines a plurality of latching slots employing a plurality of latching hooks for latching with the latching slots.

To form the latching hooks integrally with the covers, it is needed to assemble sloping pin structures within the mold of the molding machine for engaging and detaching the latching hooks from the mold when the covers are molded. However, the interior walls of the mold blocking the sloping pin structures make the removal and installation of the cover inconvenient.

Therefore, there is room for improvement within the art.

### BRIEF DESCRIPTION OF THE DRAWINGS

Many aspects of the sloping pin structures and die assemblies using the same can be better understood with reference to the following drawings. The components in the various drawings are not necessarily drawn to scale, the emphasis instead being placed upon clearly illustrating the principles of the sloping pin structures and die assemblies using the same. Moreover, in the drawings, like reference numerals designate corresponding parts throughout the diagrams.

FIG. 1 shows an exploded perspective view of a die assembly comprising a sloping pin structure and a die structure, in accordance with an exemplary embodiment.

FIG. 2 shows a cross-sectional view of the sloping pin structure taken along line II-II of FIG. 1, in accordance with an exemplary embodiment.

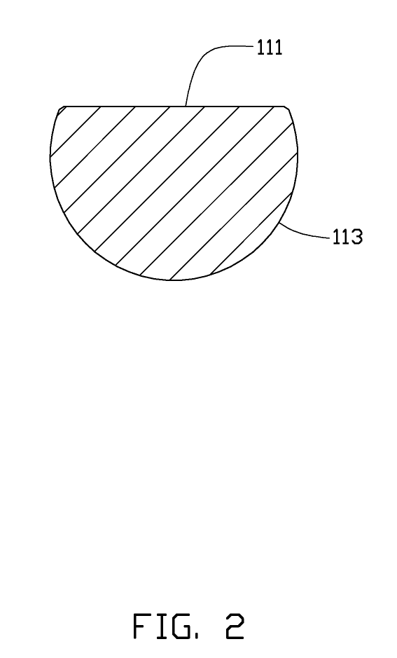

FIG. 3 shows an assembled perspective view of the die assembly, wherein, the sloping pin structure is assembled to the die structure in a reset state.

FIG. 4 shows an assembled perspective view of the die assembly, wherein, the sloping pin structure is assembled to the die structure in an ejection state.

FIG. 5 shows another cross-sectional view of the sloping pin structure, in accordance with a second embodiment.

### DETAILED DESCRIPTION

In this exemplary embodiment, the sloping pin structure is applied to a die assembly assembled within a molding machine such as plastic injection molding machine. The plastic injection molding machine described herein is just a representation of the type of molding machine that may benefit from the embodiment, it is to be understood that the embodiment may be applied to any type of molding machines including, but not limited to the plastic injection molding machine.

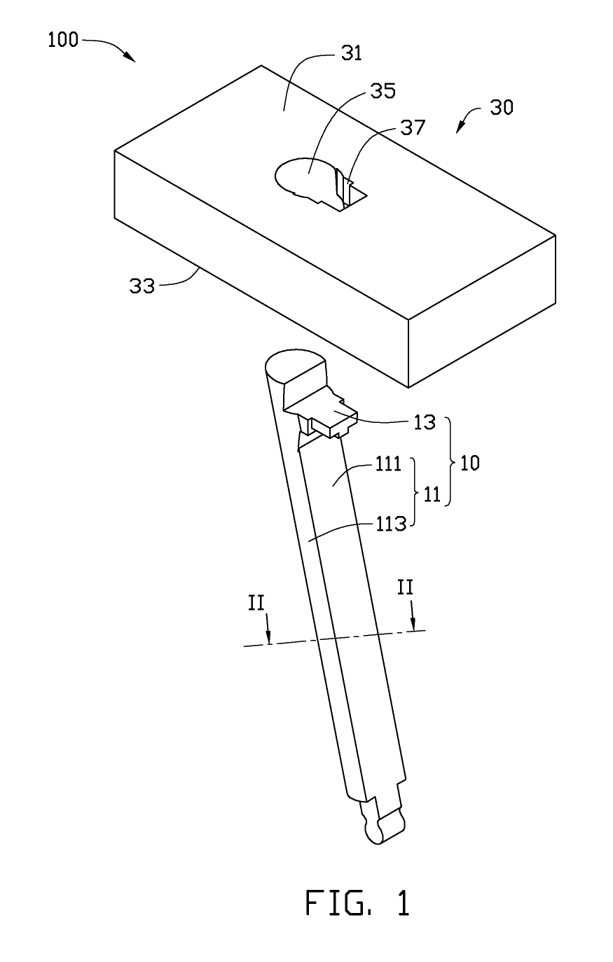

FIG. 1 shows a die assembly 100 including a sloping pin structure 10 and a die structure 30. The die assembly 100 is configured to be applied and assembled within a plastic injection molding machine (not shown) to form a plastic component such as a housing or a cover (not shown) including latching hooks using injection molding technology. The sloping pin structure 10 is detachably and slidably assembled with the die structure 30. The sloping pin structure 10 is configured to be engaged with the die structure 30 to form the latching hooks in the mold (not shown) integrally with the corresponding plastic component and is structured to eject the latching hooks from the die structure 30 during opening of the die assembly 100.

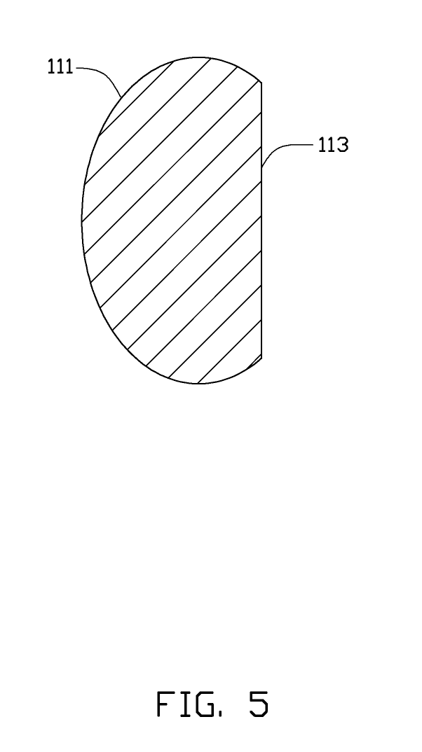

The sloping pin structure 10 includes a guiding rod 11 and a sloping pin head 13. The guiding rod 11 is a substantially elongated bar with a substantially D-shaped cross section. The guiding rod 11 includes a first resisting surface 111 and a second resisting surface 113. The first resisting surface 111 is substantially planar, and the second resisting surface 113 is substantially arcuate, and having a larger surface area than the first resisting surface 111. The first resisting surface 111 and the second resisting surface 113 cooperatively form the outer peripheral surface of the guiding rod 11. The sloping pin head 13 is disposed at one side of the guiding rod 11 and positioned adjacent to one distal end of the guiding rod 11. In the present embodiment, the sloping pin head 13 is a substantially T-shaped block protruding outwardly from the first resisting surface 111 and is positioned adjacent to one distal end of the guiding rod 11. The sloping pin head 13 forms a sharp angle (approximately 60-80 degrees) with guiding rod 11. Alternately, FIG. 5 shows another second resisting surface 113 having a substantially elliptical peripheral surface or other arc-shaped peripheral surface.

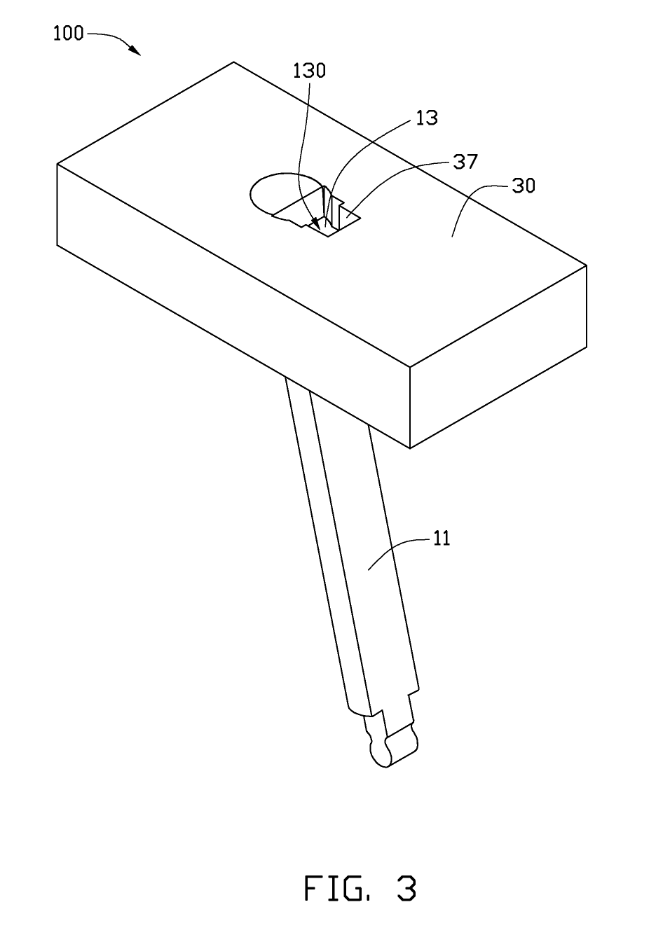

In FIG. 3, the die structure 30 is assembled within the plastic injection molding machine and is slidably assembled with the corresponding sloping pin structure 10 to form the plastic component such as housing or the cover with latching hooks. In the present embodiment, the die structure 30 is a substantially rectangular board and includes a first surface 31 and an opposite second surface 33. The die structure 30 defines a through sloping guiding hole 35 at substantially the middle of the die structure 30 with the shape and size corresponding to the guiding rod 11. The die structure 30 further includes an accommodating slot 37 recessed in the first surface 31 adjacent to and communicating with the sloping guiding hole 35. The accommodating slot 37 is configured to accommodate the sloping pin head 13 of the slopping pin structure 10 therein when the die assembly 100 is in a reset state. Thus, the sloping head 13 forms a mold cavity 130 with the accommodating slot 37 to form the latching hooks in the mold of the plastic component.

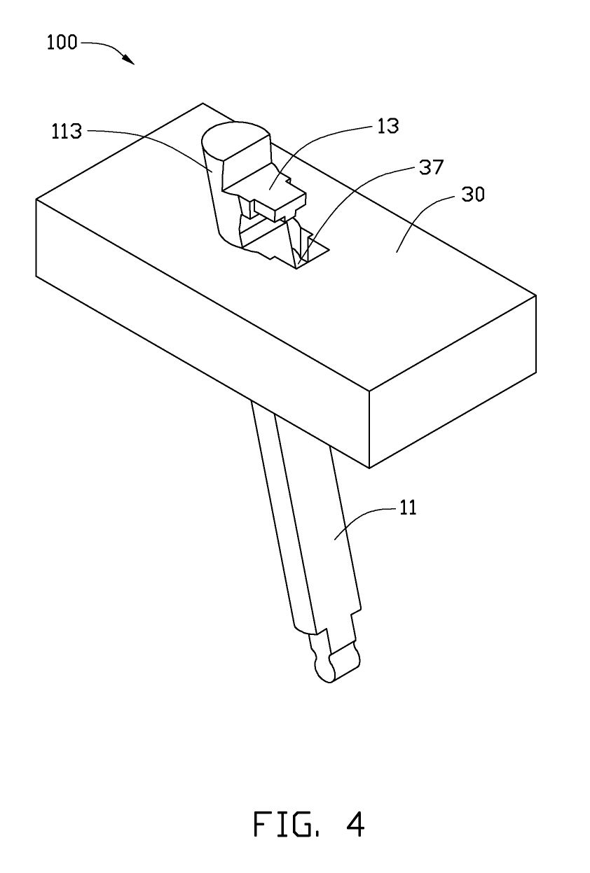

FIG. 4 shows an assembled perspective view of the die assembly 100, and the sloping pin structure 10 is slidably assembled to the die structure 30 in an ejection state. The sloping pin structure 10 forms an angle relative to the die structure 30. After the plastic component has been molded within the die assembly 100. The die assembly 100, is opened and the guiding rod 11 is driven to slide relative to the die structure 30 along the sloping guiding hole 35 to eject the molded plastic component out to detach it from the die structure 30. Because the sloping pin structure 10 forms an angle relative to the die structure 30, when ejecting the molded plastic component out, the guiding rod 11 slides relative to the die structure 30, such that the second resisting surface 113 of the guiding rod 11 resists against the sloping inner surface of the sloping guiding hole 35.

To close the die assemble 100, the guiding rod 11 is driven to slide back to the original state, and the sloping pin head 13 returns to the accommodating slot 37 of the die structure 30. At the reset state of the die assembly 100, the first resisting surface 113 of the guiding rod 11 slidably resists against the inner surface of the sloping guiding hole 35. Because the second resisting surface 113 is larger than the first resisting surface 111, when ejecting the molded plastic component out from the die structure 30, the second resisting surface 113 of the guiding rod 11 can endure a larger force than the first resisting surface 111 in the reset state.

It is to be understood that even though numerous characteristics and advantages of the exemplary embodiments have been set forth in the foregoing description, together with details of structures and functions of various embodiments, the disclosure is illustrative only, and changes may be made in detail, especially in matters of shape, size, and arrangement of parts within the principles of the exemplary invention to the full extent indicated by the broad general meaning of the terms in which the appended claims are expressed.

What is claimed is:

1. A sloping pin structure, comprising:
a guiding rod having a first resisting surface and a substantially arcuate peripheral second resisting surface; the first resisting surface and the second resisting surface cooperatively forming the outer peripheral surface of the guiding rod; and
a sloping pin head protruding outwardly from the first resisting surface and being positioned adjacent to one distal end of the guiding rod.

2. The sloping pin structure as claimed in claim 1, wherein the sloping pin head forms a sharp angle with guiding rod.

3. The sloping pin structure as claimed in claim 2, wherein the guiding rod is a substantially elongated bar with a substantially D-shaped cross section.

4. The sloping pin structure as claimed in claim 1, wherein the first resisting surface is substantially planar, the second resisting surface is substantially arcuate.

5. The sloping pin structure as claimed in claim 1, wherein the sloping pin head is a substantially T-shaped block protruding outwardly from the first resisting surface.

6. The sloping pin structure as claimed in claim 1, wherein the second resisting surface is a substantially elliptical peripheral surface.

7. A die assembly for being applied and assembled within a plastic injection molding machine to form a plastic component with latching hooks by injection molding technology, comprising:
a die structure; and
a sloping pin structure detachably and slidably assembled to the die structure, the sloping pin structure configured to engage with the die structure to in-mold form the latching hooks integrally with the corresponding plastic component and structured to eject the latching hooks from the die structure during opening of the die assembly;
wherein, the sloping pin structure includes a guiding rod and a sloping pin head, the guiding rod has a first resisting surface and a substantially arcuate peripheral second resisting surface; the first resisting surface and the second resisting surface cooperatively form the outer peripheral surface of the guiding rod; the sloping pin head protrudes outwardly from the first resisting surface and is disposed adjacent to one distal end of the guiding rod.

8. The die assembly as claimed in claim 7, wherein the die structure has a first surface and an opposite second surface, the die structure defines a sloping guiding hole therethrough, the guiding rod slidably passes through the corresponding sloping hole of the die structure.

9. The die assembly as claimed in claim 8, wherein the sloping pin structure forms an angle with the die structure, the die structure further includes an accommodating slot recessed in the first surface adjacent to and communicating with the sloping guiding hole, the sloping pin head is slidably accommodated within the accommodating slot and forms a mold cavity together with the accommodating slot to in-mold form the latching hooks of the plastic component as the die assembly in a reset state.

10. The die assembly as claimed in claim 8, wherein the guiding rod is a substantially elongated bar with a substantially D-shaped cross section.

11. The die assembly as claimed in claim 9, wherein the first resisting surface is substantially planar, the second resisting surface is substantially arcuate and has a larger surface area than the first resisting surface.

12. The die assembly as claimed in claim 11, wherein the sloping pin head is substantially T-shaped block protruding outwardly from the first resisting surface.

13. The die assembly as claimed in claim 8, wherein the second resisting surface is a substantially elliptical peripheral surface.
